(19) United States
(12) Patent Application Publication
(10) Pub. No.: US 2011/0242945 A1
(43) Pub. Date: Oct. 6, 2011

(54) Device for Combining an Alarm Clock with a Light Source

(76) Inventor: Brandon Iglesias, New Orleans, LA (US)

(21) Appl. No.: 13/037,726

(22) Filed: Mar. 1, 2011

Related U.S. Application Data
(60) Provisional application No. 61/309,330, filed on Mar. 1, 2010.
(60) Provisional application No. 61/361,836, filed on Jul. 6, 2010.

(51) Int. Cl. G04B 47/00

(52) U.S. Cl. 368/12

(57) ABSTRACT

A device for integrating an alarm clock with an independent light source is provided, including a light fixture for giving off light and alarm for emitting sound. The light fixture and alarm are in communication with an alarm clock having programmable light and alarm controls. The alarm clock is either hard-wired into existing room circuitry, thereby combining and replacing conventional alarm clocks and light switches, or in other embodiments, the alarm clock is installed on a mobile device and is in wireless communication with the light fixture. Several example embodiments are provided, including a specialized light bulb that is in wireless communication with an alarm clock application on a cellular telephone and a coupling device designed to open and close the electrical circuit providing power to a conventional light bulb when activated by a cell phone alarm clock.

### CROSS-REFERENCE TO RELATED APPLICATIONS

The present application claims the benefit of prior U.S. Provisional Application Nos. 61/309,330, filed Mar. 1, 2010 and 61/361,836, filed Jul. 6, 2010.

### FIELD OF THE INVENTION

The present invention relates generally to a highly utilitarian consumer electronics support system, and in a particular though non-limiting embodiment to a device that will replace and combine both a conventional alarm clock and a standard light switch.

### BACKGROUND OF THE INVENTION

The wake-up device and alarm clock market has been around since the 15^{th} Century. Currently, the market is dominated by three types of technology: traditional alarm clocks, cellular telephones and their applications, and wake-up lights that seek to use artificial light to help create a more natural wake-up experience.

Traditional alarm clocks range from clocks with faces and bells on the top to digital clocks that have built-in radios and soothing sounds. In recent years, alarm clocks have also been modified to include cellular telephone recharging and music connectivity capabilities as well.

Cellular telephones represent the largest portable alarm clock market in the U.S. Most cellular telephones include an alarm clock device, and some are equipped with more advanced alarm clock applications. In recent years, cell phones have begun to take a large hold on the market that was previously dominated by traditional alarm clock devices. Many are beginning to use their cell phone alarm clock function instead of purchasing a new traditional alarm clock when their alarm clocks stop working.

The wake-up light marketplace for the most part is dominated by independent niche companies that have a medical product background. Published studies at Stanford's Sleep Institute and the United Kingdom's University of Surry indicate that light within 420-490 nm wavelengths, commonly known as blue light, causes melatonin levels in the body to decrease when observed by the human eye. Lower melatonin levels are associated with greater alertness, while higher melatonin levels are associated with grogginess and sleepiness.

Currently, there is no device that wires into a room's existing lighting system or a light-bulb alarm clock device that communicates with a cell phone alarm application.

### SUMMARY OF THE INVENTION

A device for integrating an alarm clock with an independent light source is provided. The device includes a light fixture for giving off light and an alarm for emitting sound. The light fixture and alarm are in communication with an alarm clock having a programmable light control and alarm control. The programmable light control is for designating a time when the lighting fixture will be activated, and the programmable alarm control is for designating a time when the alarm will sound. The alarm clock is either hard-wired into existing room circuitry, thereby combining and replacing conventional alarm clocks and light switches, or in other embodiments, the alarm clock is installed on a mobile device and is in wireless communication with the light fixture.

### BRIEF DESCRIPTION OF THE DRAWINGS

FIG. 1 is a front view of the wall display for a preferred embodiment of the combination light switch alarm clock hard-wired into existing room circuitry, in accordance with the present invention.

FIG. 2 illustrates another embodiment of the present invention, wherein a novel light bulb has the ability to communicate with a mobile device or the combination light switch alarm clock via wireless technology.

FIG. 3 illustrates another embodiment of the present invention, wherein a light bulb coupling device opens or closes the circuit to an ordinary light bulb when activated via a wireless source.

FIG. 4 illustrates yet another embodiment of the present invention, wherein a wall socket plug-in light is activated via a wireless source.

FIG. 5 illustrates another embodiment of the present invention, wherein a wall socket coupling device opens or closes the electrical circuit to a light-emitting device.

### DETAILED DESCRIPTION OF SEVERAL EXAMPLE EMBODIMENTS

Example embodiments of the invention overcome deficiencies in the prior art by providing an alarm that facilitates the body in waking up more naturally. Gradual illumination, associated with an example embodiment of the invention, simulates a sunrise, creating an awakening experience more in line with circadian rhythms that are inherent in the body's sleep and wake cycles, allowing the user to wake more easily and completely than the current sound-only experience offered by standard alarm clocks.

Furthermore, in a presently preferred embodiment, the disclosed device seamlessly integrates both light and noise into an individual's awakening routine, and obviates the need for either an alarm clock disposed nearby (e.g., on a neighboring nightstand) or a standard light switch that is disposed within a recessed wall surface (usually near an entry way door), so that the awakening experience is both optimized with respect to space and efficiency, and greatly improved with respect to the previously limited aesthetic enjoyment associated with such devices.

In one embodiment, the combination light switch and alarm clock integrates the functionality associated with a conventional alarm clock into a wall mounted light switch, thereby resulting in a room's light source being activated by the prior activation of a previously set built-in alarm clock. In one example embodiment, the alarm is activated when the lights associated with the combination light switch and alarm clock circuit are activated. In another embodiment, the combined light switch alarm clock utilizes a living space's pre-existing resources by switching on lights activated by a switch disposed on the switch circuit after the alarm has sounded.

In still other embodiments, the device controls other, independent light sources in addition to the room lighting source, so that an operator can more easily locate the device while still awakening. In further embodiments, the device is installed in either ‘old-work’ or ‘new-work’ facilities, such as homes, hotels, lodges, apartments, etc., which are continuously being built and renovated or upgraded over time.

In certain embodiments, the device serves as either a conventional light switch or a conventional alarm clock, so that users can variably switch a desired space's lights on or off using the light switch, just as they normally would with a conventional light switch; in other embodiments, the light feature on the device's alarm is disabled so that only an audible alarm sounds. In still further embodiments, the audible alarm feature can be disabled, while a light alarm feature remains activated on the device, or elsewhere within the room, or both. In a presently preferred embodiment, the device operates in electrical communication with a standard 110-120 volt residential/commercial connector; in further embodiments, the device is equipped to handle the international 220 volt standard.

In another embodiment, the device comprises a switch with a flat or approximately flat screen. In an extended embodiment, a virtual switch pivots around a predetermined point (e.g., at or near the center point) to turn the light on and off. In this manner the entire device forms a switch that retains traditional ergonomics (e.g., the touch and feel of activating a switch), but also provides a GUI interface through a flat touch screen to provide alarm, clock, and other functions.

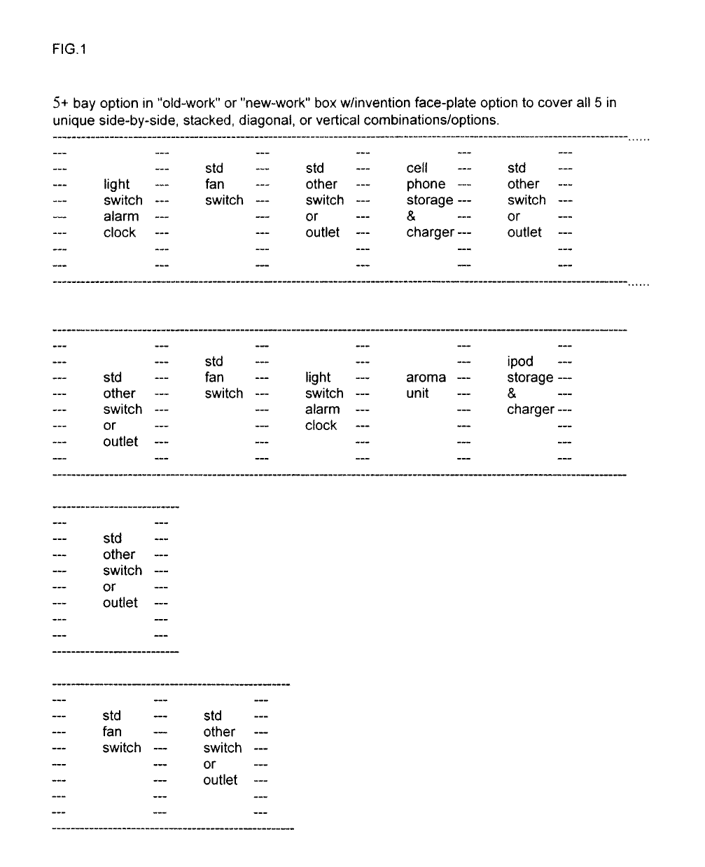

As shown in FIG. 1, at 100, a combination light-switch alarm clock, hard-wired into existing room circuitry, is shown. The time display 101 may display Military or Standard time, based on the user's input. The user also has the option of displaying several calendar features 102, including day, month, and year. The light alarm 103 and the audible alarm 104 can be enabled and disabled by the user. Personalized alarms with varying times and settings 105 can be made for each day of a given month.

According to alternative embodiments, the device also features an aroma generator that stimulates the sense of smell. The device is programmable so that activation of the aroma generator occurs prior to the alarm being activated so as to ensure that a given space is impregnated with a desired scent prior to activation of the light and/or audible alarm features; in other embodiments, the aroma generator activates after one or more of the alarm features has been activated. By stimulating the senses of sight, smell and hearing, an environment is created which maximizes the potential for an individual to awaken fresh and alert in order to begin their waking hours.

In one specific embodiment, the aroma generator is disposed within a separate, modular bay of the device's housing. Similarly, the device can be equipped with a side bay compartment that houses a toy figurine or a mechanical device such as a cuckoo clock or the like as an option for use in a child's room. In still further embodiments, a student's suite is configured to comprise bays for a pencil sharpener module, or a camera charging module, etc.

In one particular embodiment, the system features between one and perhaps a half-dozen individual bays, which can be installed either horizontally or vertically or in any feasible combination, including diagonally. In another embodiment, the aroma dispenser features a modular, replaceable scent re-loading means, and in other embodiments a low-level aroma light indicator is provided for low-level warning communication purposes. In further embodiments, a compact, forced-draft circulation system equipped with a modular scent warmer ensures immediate wide-spread distribution into a desired space.

In still further embodiments, the device comprises a side bay compartment having a slave switch that receives and/or transmits information from a master switch so as to facilitate control of other slave switch driven devices. For example, a side bay could include an IPOD™ docking station or a cell phone holder, in each instance possibly in communication with a charger or a rechargeable battery station. Side bays could also further comprise one or more speakers. In other embodiments, the side bay serves to house and contain wires and the like so that clutter usually accumulated in a room in connection with a plurality of electronic devices is now hidden from view.

Those of ordinary skill in the art will readily appreciate that a virtually limitless combination of electronic hook ups and communication ports can be accommodated using the presently disclosed combined light switch and alarm clock without departing from the scope of the present invention. For example, a device may be equipped such that a first side bay facilitates support of a cell phone system (either with or without a battery charger) and a second bay stores a recharging IPOD™, while a third bay is used to contain and hide the wires associated with the devices while still keeping them readily available should access thereto be required.

Still other embodiments might include a baby's suite, comprising, for example, a radio frequency walkie-talkie feature and a video recorder. According to the presently preferred embodiment, the side bay(s) are modular in nature, and will flexibly incorporate new technologies into currently contemplated combined light switch and alarm clock systems.

The device can also be used to transmit instructions across either a hard-wired or wireless support system, so that events occurring outside of the room are initiated when the alarm clock function of the invention is activated (for example, a coffee maker in the kitchen can be turned on either before or after the alarm's activation).

In short, the device can be equipped to handle any number of electronic control functions activated in conjunction with the presently disclosed system. Representative examples of such control functions and other related configuration and performance options include, but are not limited to:

Activation of a light alarm

Lights turn on before sound alarm activation (either gradually or instantly)

Lights turn on after sound alarm is activated (either gradually or instantly)

Lights turn on together with sound alarm activation (either gradually or instantly)

Lights turn on without alarm upon demand (per a conventional light switch)

Audio level adjustment (e.g., high/medium/low, etc.)

Tone adjustment (tone, beep, radio, custom song, etc.)

Snooze option

Alarm On/Off option

Calendar features displaying day, month, year, etc.

Military Time (24-hour) or Standard Time (12-hour) display options

Modular faceplate to change-out colors, textures and designs

Modular old- or new-work box for wall mounting

Battery back-up in case power-outages (changeable from front faceplate)

Battery strength indicator light

External device input adaptor for accessories purchased separately

Power output adaptor for portable device recharging (with or without adaptor)

Modular, interchangeable display for different backlight colors, etc.

A plurality of exemplary configurations, including representative examples of the system's basic functions, add-ons, side bays, alarm features, etc., are envisioned, though those of ordinary skill in the pertinent arts will appreciate that any number of other such features and modalities can be achieved in a manner consistent with the present disclosure.

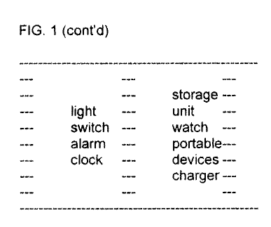

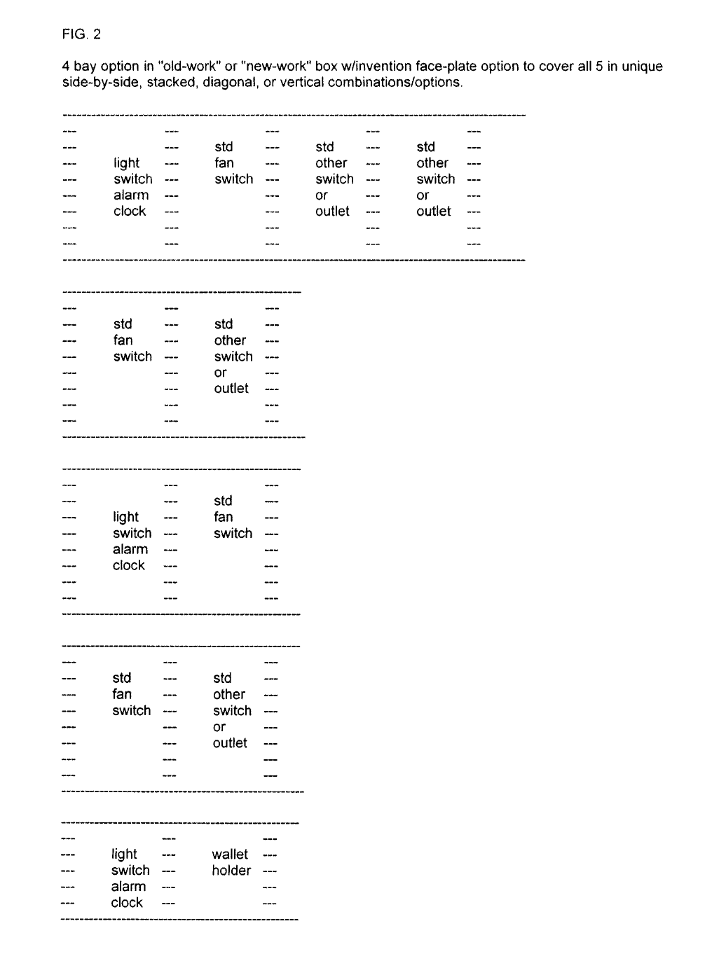

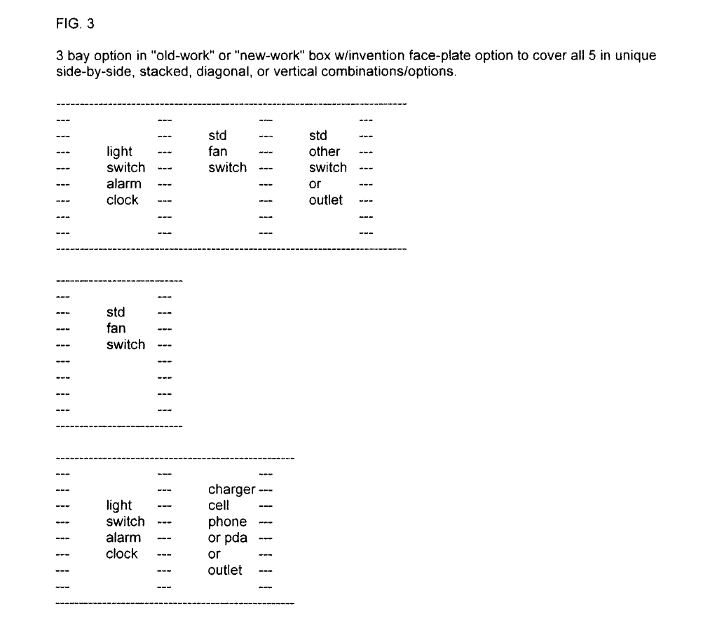

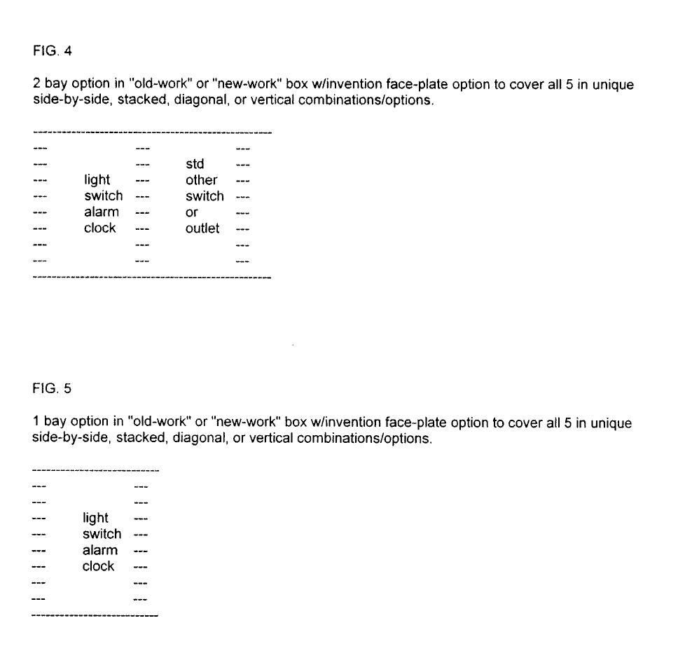

Still further modifications, arrangements and dispositions of related features and functions are contemplated as residing within the scope of the invention, as seen, for example, in FIGS. 2 through 6.

In an example embodiment, a light bulb 202 with a built-in alarm clock and/or independent circuitry/switching options and a cell phone 201 communicate with each other via wireless technology 203. The light bulb 202 is activated either instantaneously or smoothly in a ramp-up style when the cell phone 201 alarm clock goes off. This example embodiment allows a user to buy a special light bulb 202 and link it to his/her cell phone or other communication device 201 to instantly add light to his/her awakening routine.

In another example embodiment, a coupling device 303 with a built-in alarm clock and/or independent circuitry/switching options and a cell phone 301 communicate via wireless technology 305. The light bulb 302 turns on either instantaneously or smoothly in a ramp-up style when the cell phone 301 alarm clock goes off, thereby activating the coupling device 303, causing the coupling device to open and/or close the electrical circuit to the light bulb 302. This example embodiment allows a user to buy a coupler, screw it into an existing light socket or other connection 304, and once installed, screw in or connect a standard light bulb or light emitting device to instantly add light to his/her awakening routine.

In yet another example embodiment, a plug-in wall socket alarm device 402 with a built-in alarm clock and/or independent circuitry/switching options and a cell phone 401 communicate via wireless technology 404. The integrated light located on or within the device 402 turns on either instantaneously or smoothly in a ramp-up style when the cell phone 401 alarm clock goes off, through the activation of the coupling device 402 opening and/or closing the electrical circuit to the integrated light bulb. This example embodiment allows a user to buy a plug-in device 402, plug it into an existing socket or connection 403, and once installed, add light to a wake-up routine.

In yet another example embodiment, a plug-in wall socket coupling device 502 with a built-in alarm clock and/or independent circuitry/switching options and a cell phone 501 communicate via wireless technology 504. When the cell phone 501 alarm clock goes off, the coupling device 502 opens and/or closes the electrical circuit to the light emitting device (not shown). This example embodiment allows a user to buy a plug-in coupling device 502, plug it into an existing socket or connection 503, and once installed, add light to a wake-up routine.

In yet another example embodiment, a dedicated light on a cell phone 602 communicates with either a cell phone or the alarm clock light switch 601 and switches on instantaneously or smoothly in a ramp-up style when the cell phone 601 alarm clock goes off, via wireless communication 603 between the cell phone 601 and the dedicated light 602.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. A device for integrating an alarm clock with a light source, said device comprising:
a light fixture; and
an alarm, wherein said light fixture and said alarm are disposed in communication with a clock;
said device further comprising a programmable light control and a programmable alarm control, wherein said programmable light control is used for designating a time when said light control activates said lighting fixture, and said programmable alarm control is used for designating a time when said alarm control activates said alarm.

2. The device of claim 1, wherein said clock is hard-wired into existing room circuitry and integrated with a wall-mounted light switch.

3. The device of claim 1, wherein said clock is disposed in wireless communication with said light fixture.

4. The device of claim 1, wherein said device further comprises an aroma generator, and
said device further comprises a programmable aroma control, wherein said programmable aroma control is used for designating a time when said aroma control activates said aroma generator.

5. The device of claim 1, further comprising one or more auxiliary light sources, and
wherein said device further comprises auxiliary light controls for activating said auxiliary light sources.

6. The device of claim 1, further comprising at least one bay compartment having a slave switch, said slave switch used for receiving and transmitting a signal from a master switch so as to facilitate control of one or more other slave switch-driven devices.

7. The device of claim 2, wherein said programmable light control is disengageable, so that said light fixture is activated by said wall-mounted light switch.

8. The device of claim 3, wherein said device further comprises a mobile communication device application.

9. The device of claim 1, further comprising a GUI so that a virtual activation switch is established.

10. The device of claim 9, wherein said GUI is used by an operator to control light, alarm and other functions activated on the device.
